(19) United States
(12) Patent Application Publication
(10) Pub. No.: US 2016/0154229 A1
(43) Pub. Date: Jun. 2, 2016

(54) SPECTRALLY-ENCODED HIGH-EXTINCTION POLARIZATION MICROSCOPE AND METHODS OF USE

(71) Applicant: BOARD OF REGENTS, THE UNIVERSITY OF TEXAS SYSTEM, Austin, TX (US)

(72) Inventors: Thomas E. Milner, Austin, TX (US); Biwei Yin, Austin, TX (US); Jeffrey Russel Kuhn, Austin, TX (US)

(21) Appl. No.: 14/963,900

(22) Filed: Dec. 9, 2015

Related U.S. Application Data
(63) Continuation-in-part of application No. PCT/US2014/041570, filed on Jun. 9, 2014.
(60) Provisional application No. 61/832,857, filed on Jun. 9, 2013.

(51) Int. Cl. G02B 21/00; G02B 21/06; G06T 7/00; H04N 5/225; H04N 5/372; G02B 21/36; G02B 21/26

(52) U.S. Cl. CPC G02B 21/0092; G02B 21/36; G02B 21/06; G02B 21/26; H04N 5/2254; H04N 5/2256; H04N 5/372; G06T 7/0018

(57) ABSTRACT

Described herein is a polarization microscope that uses spectral-encoding of the polarization state for cellular imaging. The spectral-encoded polarization microscope is both sufficiently fast for cellular imaging and is compatible with high extinction optics required to image molecular structures and assemblies. The spectral-encoded microscope allows for the polarization state of light presented to the specimen to sample discrete states over the entirety of the Poincaré sphere while simultaneously giving a null measurement of the observed cellular birefringence. Sampling over the entire Poincaré sphere allows the microscope to determine of specimen phase retardation due to both linear and circular birefringence. The spectral-encoded polarization microscope can be operated in a slightly off-null state that will improve signal-to-noise.

### CROSS-REFERENCE TO RELATED APPLICATIONS

The present application claims priority from and is a continuation-in-part of PCT Application No. PCT/US2014/041570, filed Jun. 9, 2014, which claims priority to U.S. Provisional Application Ser. No. 61/832,857, filed Jun. 9, 2013, all of which is incorporated by reference herein in their entireties.

### BACKGROUND

The invention generally relates to polarized light microscopy.

Cell structures such as polymers, membranes or vesicles are birefringent. Birefringence can be detected and imaged based on how these structures interact with polarized light. However, to fully characterize these interactions, the polarized light must be modulated to allow different polarization states incident on the sample.

Modulated polarization microscopy (MPM) has the demonstrated ability to image cytoskeletal elements and other structures in living cells. Although these structures may be structurally smaller than the resolution of the microscope imaging system, such structures can be visualized using MPM. To visualize these structures, images must be acquired while the polarization state of the illuminating light is modulated or varied over time or another domain. State of polarized light that interacts with the sample is modified. Image detail is encoded as small changes in intensity as the polarization state is modulated. Detecting changes in image intensity as one modulates the polarization state allows one to determine specific polarimetric signals (e.g. birefringence) of the specimen from the detected signal. However, lateral movement of cellular objects over the time period of polarization modulation can degrade the value of recorded data. Such movement artifacts are most readily observed with tiny structures that may move one or more pixels during the course of polarization modulation. Therefore, an important factor that limits the performance of MPM is the speed of modulation and the ability of the camera to record high resolution images (both in spatial resolution and bit depth) at rates sufficiently fast to mitigate specimen movement artifacts.

Procedures to modulate the polarization state have, heretofore, involved devices such as mechanical rotation of polarizers or waveplates (e.g., 'l2 wave); liquid crystal retarders, or Faraday rotators. Mechanical rotation of polarizers or 'll-wave plates is limited by the mechanical inertia of the element and is a slow process and frequently introduces mechanical vibration and image blurring. Furthermore, mechanical rotation of a single element (e.g., a polarizer or 'll-waveplate) may not provide sufficient sampling of the full set of polarization states as visualized on the Poincare sphere and determination of the specimen's components of linear and circular birefringence or other polarimetric signals may not be possible. Liquid crystal retarders can provide a complete sampling of the Poincare sphere but they are slow and they provide poor polarization purity (contrast ratios). Poor polarization purity reduces the intensity changes due cellular birefringence and other polarimetric signals. The slow speed of liquid crystal retarders prevents observation of many cellular processes in real time, while the poor polarization purity limits the types of cellular structures that can be observed. Faraday rotators are fast and compatible with high polarization purity. Faraday rotators, however, introduce technical challenges and do not provide a full sampling of the Poincare sphere and thus may not provide sufficient data to isolate linear and circular birefringence or other polarimetric signals. The accurate modulation of the polarization state using Faraday rotators cancan require generating magnetic field lines that are strictly parallel to the axis of the Faraday rotator rod. In practice, generating strictly parallel field lines using electromagnets is impossible. Although the magnets may be designed such that the field lines are nearly parallel to the optical axis, this leads to inhomogeneous rotation over the cross-section of the Faraday rotator rods. Faraday rotator magnets may require water cooling. Heating of the magnets can distort the relationship between the power and the rotation. Thermistors in the magnets provide temperature measurement that may be used to compensate and correct recorded data. These problems associated with use of mechanical rotation, use of liquid crystal retarders and Faraday rotators become irrelevant and are eliminated with the present invention.

None of these devices are capable of providing the necessary modulation of the polarization state of light at a speed sufficiently fast to visualize moving, living specimens.

### SUMMARY OF THE INVENTION

Provided herein are systems, methods and apparatuses for a Spectrally-Encoded High-Extinction Polarization Microscope. The polarization microscope generally comprises a variable wavelength light source; a first polarizer optically coupled to the variable wavelength light source, wherein the first polarizer transmits incident light in a pure polarization state; a first retarder module optically coupled to the first polarizer; a specimen stage optically coupled to the first retarder module, wherein the specimen stage holds a specimen in the optical pathway of the light received from the first retarder module; a second retarder module optically coupled to the specimen stage, wherein the second retarder module is an opposite-signed retarder with respect to the first retarder module; a second polarizer or analyzer optically coupled to the second retarder module, wherein the second polarizer or analyzer selects an orthogonal polarization state to the first polarizer; an optical capture device optically coupled to the second polarizer or analyzer, wherein the optical capture device captures light passing through the second polarizer. In one embodiment, the retarder modules include one or more retarders and/or polarization rotators.

A method of visualizing a specimen using a polarization microscope comprising: placing the specimen on a specimen stage of a polarization microscope; and obtaining images of the specimen at one or more wavelengths each corresponding to a polarization state incident on the specimen.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 depicts a schematic diagram of a polarization microscope;

FIG. 2 depicts a schematic diagram of a Poincare sphere;

FIG. 3a depicts a schematic diagram of an alternate embodiment of a polarization microscope;

FIG. 3b depicts a schematic diagram of an alternative embodiment of a polarization microscope;

FIG. 3c is a top view of the first and second retarder modules from FIG. 3b;

FIG. 4 is a cross-sectional view of a schematic diagram of one embodiment of the light source;

FIG. 5a is a birefringence image of a diatom at high magnification; FIG. 5b is a birefringence image of the diatom at a low magnification;

FIG. 6 is a schematic diagram of the microscope optical train;

FIG. 7a is an image using the polarization microscope showing a BM3.3 T cell attacking a target and individual microtubules;

FIG. 7b is an image using the polarization microscope showing microtubules and actin-based stress fibers; and

FIG. 7c is an image using the polarization microscope showing a small region of a 3T3 fibroblast cell that includes a microtubule (left panel) decorated with numerous small vesicles (right panel).

While the invention is susceptible to various modifications and alternative forms, specific embodiments thereof are shown by way of example in the drawing and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein. The words proximal and distal are applied herein to denote specific ends of components of the instrument described herein. A proximal end refers to the end of an instrument nearer to an operator of the instrument when the instrument is being used. A distal end refers to the end of a component further from the operator and extending towards the surgical area of a patient and/or the implant.

The use of the terms “a” and “an” and “the” and similar referents in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. The word “about”, when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In one embodiment, a polarization microscope includes a variable wavelength light source; a first polarizer that transmits light in a pure polarization state (linear, circular, elliptical, radial, or azimuthal) optically coupled to the variable wavelength light source. The first polarizer is optically coupled to a first retarder (linear, circular or elliptical). A specimen stage is optically coupled to the first retarder, wherein the specimen stage holds a specimen in the optical pathway of the light received from the first retarder. A second retarder, having the opposite-sign to the first retarder, is optically coupled to the specimen stage to receive light that passes through the specimen stage. A second polarizer or analyzer is optically coupled to the second retarder, the second polarizer or analyzer being arranged to select an orthogonal state to the first polarizer. An optical capture system is optically coupled to the second polarizer.

The variable wavelength light source, in one embodiment, is capable of producing light having a wavelength from between about 350 nm to about 800 nm.

In one embodiment, the first polarizer and/or the second polarizer is a polarizing prism.

In one embodiment, the first and second retarders are optically coupled with crystal polarized light rotators. The crystal polarized light rotators may be composed of tellurium dioxide or quartz. In one embodiment, the polarization microscope comprises a first crystal polarized light rotator and a second crystal polarized light rotator, wherein the first crystal polarized light rotator and the second crystal polarized light rotator are matched crystal rotators.

The degree of rotation of the first polarized light rotator and the second polarized light rotator may be based on the wavelength of the incident light.

In one embodiment, the optical capture device is a charged coupled device or scientific CMOS imager with adequate sensitivity, resolution and speed of image capture.

During use, light from the first polarized light rotator and the first retarder passes through the specimen held on the specimen stage. Alternatively, light from the first crystal polarized light rotator and the first retarder is reflected from the specimen held on the specimen stage.

In an embodiment, the retarders are a pair of matched rotators (circular retarders) that cause a phase delay between left and right circular polarized light. In another embodiment, the retarders are matched elliptical retarders formed by a rotator (circular retarder) and a waveplate (linear retarder) optically coupled to each other. In another embodiment, the retarders are elliptical retarders formed by two or more waveplates oriented with respect to each other.

In an embodiment, a method of visualizing a specimen using a polarization microscope includes: placing the specimen on a specimen stage of a polarization microscope as described above and obtaining images of the specimen at one or more wavelengths. Obtaining images of the specimen may be performed by periodically changing the wavelength of light impinging on the specimen and capturing images of the specimen after each change of wavelength of light. Each change of wavelength may be accomplished in between 1 nanosecond and 10 millisecond, alternatively at least 1 millisecond or longer for bigger aperture ATOF's, since the response time is going to be longer, whereas acquisition of one image can be accomplished in as little as 1 milliseconds. Imaging of the biological specimen may be performed continuously or intermittently as long as a set of images required for characterizing polarization state changes are acquired within a sufficiently short time so that movement of cellular components is small compared to one pixel size on the specimen. In one embodiment, a set of images (e.g., 2 to 25 images) is produced by capturing images in succession (e.g. 10-20 milliseconds apart). In one embodiment, a pulsed light source is employed so that images are captured as with a strobe.

In an embodiment, the method further comprises modulating the polarization state of the light on the Poincare sphere to produce both azimuthal (about the poles) and longitudinal (about an equatorial axis) movement on the Poincare sphere by altering the wavelength of the light produced by the variable wavelength light source.

In an embodiment, the method further comprises: adjusting the orientation axis of the first polarizer with respect to the second polarizer (analyzer) so that the first polarizer and the second polarizer (analyzer) are not fully orthogonal; and obtaining images of the specimen while the first polarizer and second polarizer are not fully orthogonal. The method may also include calibrating the polarization microscope by determining the polarization state of the light when the second polarized light rotator and the second waveplate are removed from the optical path. Determining the polarization state of the light, in one embodiment, may be performed by methods known in the art of light polarization analysis such as rotating the second polarizer (analyzer) through discrete angles and analyzing the data collected by the optical capture device. The polarizers should polarize all wavelengths of light at a nearly equivalent extinction within the operating wavelength range.

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

As used herein the term “retarder” refers to an optical element (composed of one or more optical components) is an optical element that provides an optical phase delay (Δφ) between a pair of orthogonal polarization states. The orthogonal states may be linear states oriented at ninety degrees, left- and right-circular polarization states, or orthogonal elliptical states. Other polarization states may be selected or non-null type of measurement. A retarder is specified by either of the two polarization states (sometimes called eigenstates) that propagate through the retarder element without a phase delay and the phase delay (Δφ) between the two orthogonal eigenstates. For example, a waveplate is linear retarder and is specified by two linear orthogonal states that when propagating through the retarder experience a phase delay. The retarder pair in the microscope (before and after the specimen) are configured so that if these two elements were positioned sequentially light would experience no change in the polarization state. An elliptical retarder can be formed, for example, by a sequential combination of a rotator (circular retarder) and a waveplate (linear retarder). Other combinations are known in the art, for example, an elliptical retarder may be formed from two linear retarders that are oriented at 45 degrees with respect to each other.

As used herein the term “polarizer” refers to optical elements that transmit light in a pure polarization state (linear, circular or elliptical) with high extinction for each light wavelength emitted or selected from the light source. One embodiment of a polarizer is an optical element that transmits a pure linear polarization state. Polarizers polarize all wavelengths of light equally within the operating wavelength range.

Described herein is a new approach to rapidly modulate the polarization state of light on the Poincaré sphere to produce both azimuthal (about the poles) and longitudinal (about an equatorial axis) movement on the Poincaré sphere. High speed modulation of the polarization state is combined with a relatively high speed imager (100 Hz or faster frame rates) that can capture images corresponding to discrete polarization states of light interacting with the specimen. To the extent that movement of sample constituents can be frozen during the period of modulation, much better birefringence signal-to-noise ratio for individual objects in the specimen is obtained. The design of the microscope is simple, and utilizes components that maintain high polarization contrast ratios. Furthermore, as will be explained, the design provides, for obtaining null or near null measurements of polarization states. The microscope design can be easily implemented by other laboratories making it useful for a wide range of studies.

Microscopy has been advancing on several fronts to improve resolution in both space and time. Better Z-axis resolution has been achieved using confocal or two-photon microscopy whereas a variety of approaches have now broken through the diffraction barrier to obtain superresolution. However, these techniques are largely based on fluorescence which can require labeling specific proteins or structures. As powerful and important as fluorescence microscopy is, fluorescent probes bleach thereby limiting the time of observation.

Polarized light microscopy provides a different mode of imaging with contrast based on intrinsic structure and spatial orientation. Polarized light microscopy has long been used for imaging spindle microtubules based on their birefringence. However, there are many cellular structures that can be detected with high contrast under polarized light including various filament systems (actin, microtubule, intermediate filaments and collagen), membrane boundaries including those of the plasma membrane, cellular vesicles and various organelles and cellular structures that show crystalline-like organization. Membrane boundaries exhibit edge birefringence that can be imaged with better precision than predicted by the traditional resolution limits. Indeed, preliminary data suggest that polarized light microscopy may be applied to image viral particles in cells. Furthermore, nanoparticles offer a unique approach for labeling proteins and observing protein interactions using polarized light. Finally, unlike with fluorescence, cells can be continuously imaged for long periods of time.

In order to realize the full capabilities of polarized light microscopy and visualize structures that modify the polarization of light, one cannot simply image the cell using crossed polarizers. The small changes to the polarization state of light induced by biological structures are mostly masked by un-scattered light that does not change its polarization state. The birefringence signal is dependent on angle with respect to the orientation of the polarizers. At a fixed orientation, some structures will be visible while others are not. Modulation of the polarization state allows objects of various orientations to be visualized. In addition, the kind of birefringence can be extracted, whether the birefringence is linear or circular.

Contrast in polarized light images arises from changes in phase and/or amplitude of orthogonally polarized states as they travel through the specimen. For example, form-birefringence is exhibited in cells and tissues by various polymers including collagen and the cell cytoskeleton. The electric field of incident light oscillating perpendicular to the fibers (E_{⊥}) induces surface charges that create an induced field (Eₒ) within the fiber. The induced field (Eₒ) anisotropically modifies forward scattered light so that phase and amplitude of E_{⊥} is altered relative to the electric field component polarized parallel to the fibers (E_{∥}). The incremental phase retardation (δᵢ) incurred by the perpendicular component (E_{⊥}) results in slower light transmission and larger refractive index (nₛ) than that experienced by light polarized parallel to the fiber axis (E_{∥}) with refractive index n_{f}. The numerical difference between indices of refraction of light oscillations polarized along fast and slow axes is the form-birefringence (Δn=nₛ−n_{f}). Incremental phase retardations (δᵢ) accumulate through fibrous structures and the composite phase retardation (δ) between components polarized parallel (E_{∥}) and perpendicular (E_{⊥}) to the fibers after propagating a distance Z is:

$$δ = \frac{360 \cdot Δ n}{{λ}_{o}} \cdot Z ; \qquad ( Eq . 1 )$$

where δ is given in degrees. In addition to phase retardation between E_{∥} and E_{⊥}, forward scattered light may have a scattering anisotropy resulting in differential attenuance of light amplitudes. This quantity is given by the form-biattenuance (Δχ) and sometimes called dichroism). Similarly, the composite relative attenuation (∈) between components polarized parallel (E_{∥}) and perpendicular (E_{⊥}) to the fibers after propagating a distance Z is:

$$ɛ = \frac{360 \cdot Δχ}{{λ}_{o}} \cdot Z ; \qquad ( Eq 2 )$$

where E is given in degrees. Effect of form-birefringence (Δn) and form-biattenuance (Δχ) between parallel (E_{∥}) and perpendicular (E_{⊥}) field components may be accounted for, respectively, by real (Δn) and imaginary (Δχ) parts of the complex differential wavenumber (β):

$$β = {β}_{re} + i {β}_{im} = \frac{2 π}{{λ}_{o}} ( Δ n + i Δχ ) . \qquad ( Eq . 3 )$$

Relative amplitude and phase between perpendicular (E_{⊥}) and parallel (E_{∥}) field components can be expressed mathematically by the complex relative-amplitude (E_{⊥}/E_{∥}). After forward scattered light propagates through a distance (Z), complex relative-amplitude is given by

E_{⊥}(z)/E_{∥}(z)=exp(−βᵢₘ·Z)·exp(iβᵣₑ·Z). (Eq. 4)

Here, βᵣₑ is proportional to form-birefringence (Δn) and βᵢₘ is proportional to form-biattenuance (Δχ). Accurate quantitative measurements of Δχ in cells have not been reported.

Another type of polarization modification seen in cells is known as edge birefringence, which can be seen at the boundary between dielectric interfaces such as between water and cell membranes. Edge birefringence is an incompletely understood phenomena thought to arise due to interference at boundaries where light from three different paths mix. Various investigators using microscopy have noted that edge birefringence can allow for determination of boundaries with greater accuracy than is obtainable with other types of microscopy. This feature of edge birefringence is consistent with our own observations and is of notable value in experimental studies. Certain crystalline structures such as bone, glycogen granules are intrinsically birefringent. For reasons that are not clear at present, large T cell secretory vesicles can strongly modify the polarization state of light and may be an example of intrinsic birefringence. Another type of polarization change is transient birefringence observed during neuronal action potential propagation. There seem to be several different cellular sources of this birefringence and they have not been well characterized. At least some of the light polarization change seems to arise from responses of membrane proteins and/or lipids to the change in potential. Based on the kinetics of the structural change, a second component has been attributed to calcium release from the sarcoplasmic reticulum. Finally, although circular birefringence is believed to be present in various cellular constituents (e.g. glucose) previous forms of circular birefringence have not provided contrast to observe these sorts of structures.

While there are many cellular sources that can change the polarization of incident light, these signals are typically quite small and can be obscured by background light and optical aberrations. Furthermore, the brightness of the object modifying the polarization state depends on the orientation of the specimen with respect to the polarization angle or phase. To separate sample birefringence from the background, it is necessary to modulate the polarization state of light illuminating the specimen and then determine the birefringence quantitatively from the measured changing amplitudes. We refer generically to this imaging methodology as modulated polarization microscopy.

A modulated polarization microscope that changes the incident polarization state by changing the incident wavelength of light on the specimen provides a novel contrast paradigm for microscopy. Some objects in a specimen may modify the polarization state of incident light on the basis of wavelength. As understood in the art of polarimetric light scattering, the scattering matrix relates the polarization state of scattered light to that of incident light. As is well known in the art, the scattering-matrix is generally wavelength dependent. Hence, to generate contrast in the MPM using a variable wavelength source, an object with little or negligible birefringence in the specimen may scatter incident light polarizations differently with wavelength. This contrast mechanism is distinct from conventional intrinsic and/or form birefringence which may be weakly wavelength dependent.

Any suitable camera with suitable speed, resolution, high sensitivity, and low noise may be used to record the images. In order to take advantage of the fast modulation rate, the camera frame rate also must be proportionally fast. At the same time, since calculation of birefringence depends on small changes in light intensity, the numerical precision (bits per pixel) and resolution (number of pixels) is also important. The camera should also have low noise and high sensitivity.

Exemplary cameras in the contemporary art that may be used include the Hamamatsu Orca Flash 4, the Andor “Zyla” and similar cameras.

In a previous MPM system, plane polarized light is modulated using two matched Faraday rotators to rotate the plane of linear polarized light through about 90 degrees but in opposite directions. Faraday rotators are capable of modulating polarized light at speeds better that 1 KHz and glass-based systems like ours maintain a high degree of extinction (˜50,000) whereas liquid crystal retarders are relatively slow (requiring 0.1 seconds to settle down before an image is acquired) and they give low birefringence contrast corresponding to poor polarization extinction ratios (<1000).

While producing good contrast static images, liquid crystal rotators were not useful for providing images of cytoskeletal elements in living fast moving cells. Faraday rotators could be used to visualize small structures in living cells, but are limited in that they only rotate plane polarized light and thus cannot sample the entire Poincaré sphere. Faraday rotators also require input of large amounts of electrical power into the magnets where heating becomes a problem for consistent operation of the instrumentation. High-current Faraday rotators must be water cooled and, even with cooling, one must constantly compensate for temperature changes in Faraday rotating elements.

Given the many problems with previous designs, a novel approach is designed to perform modulated polarization microscopy. A number of important features guided this design that enables harnessing the power of polarized light microscopy not demonstrated heretofore. The first feature was the ability to modulate the polarization state of incident light over the entire Poincaré sphere and record images at high speed. Secondly, it was important to capture digital images with high numerical precision and high resolution. Thirdly, it was important to use an optical train and components that maintain high polarization purity. Fourthly, it was important that the modulation approach allows for a null measurement. This means regardless of how the polarization state is modulated before the specimen, after the specimen it is demodulated so that any captured light is due to modification of the polarization by the specimen. Fifthly, support is provided that an improvement in signal-to-noise ratio is obtained if the polarizer and analyzer are not orthogonal. Rather, signal to noise may be improved if the polarizer and analyzer are oriented off from the orthogonal configuration resulting in a partially null state. Finally, a system is provided that could be readily manufactured and made available to many users. The combination of different wavelengths and a set of retarders produce a trajectory of polarization states incident on the specimen over the Poincare sphere. That trajectory of incident polarization states provides an adequate sampling of the Poincare sphere, sufficient to characterize polarization changes induced by the specimen, or for example, calculate the birefringence properties of cellular components. While no single set of retarders can cover the entire Poincare sphere, different sets of retarders can be used to generate different trajectories of polarization states incident on the specimen over the Poincare sphere. The set of retarders chosen provides polarization states that can include linear, circular, and ellipitical states.

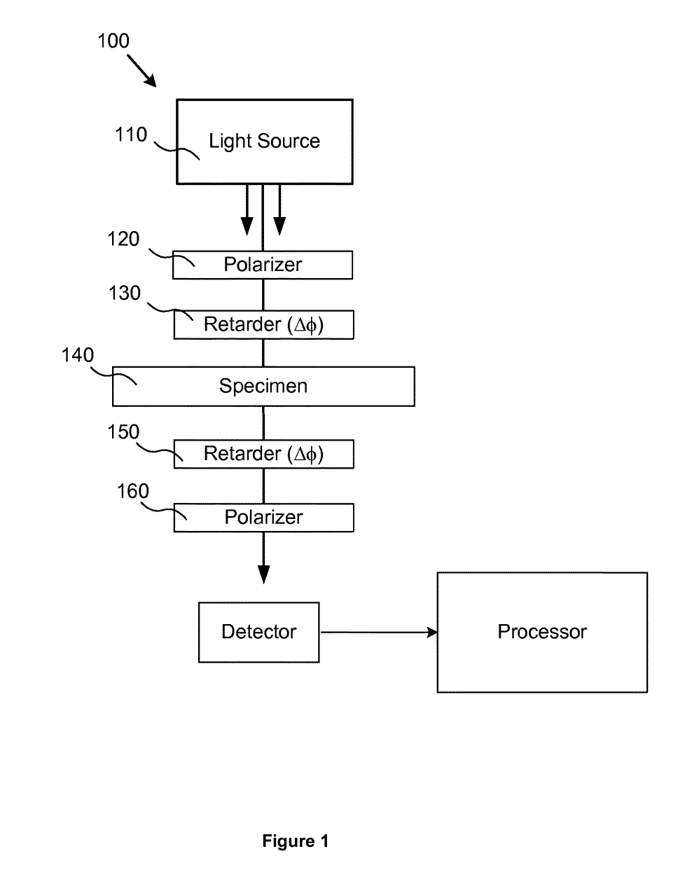

A schematic diagram of a polarization microscope 100 capable of performing modulated polarization microscopy is depicted in FIG. 1. Polarization microscope 100 includes a variable wavelength light source 110. Variable wavelength light source 110 is capable of emitting light at multiple wavelengths in a spectral range of about 300 nm to about 1000 nm. In some embodiments, variable wavelength light source 110 is capable of producing light having a wavelength from between about 350 nm to about 800 nm. Variable light source 110 may have a fast switching time between spectral emissions. In some embodiments, the switching time is shorter than the blanking interval between successive frames of the camera. In some embodiments, variable wavelength light source 110 is capable of changing emission wavelengths at a maximum speed of between 1 microsecond/wavelength and 5000 microseconds/wavelength. Variable wavelength light source 110 may be rapidly switched between emission wavelengths and provide sufficient radiant flux incident on the specimen over a narrow band of wavelengths. Examples of variable wavelength light sources that may be used include, but are not limited to: supercontinuum sources; arc lamps; plasma lamps; induction lamps; combination of diode lasers; tunable lasers, superluminescent diodes (SLED), light emitting diodes (LED); Digital Light Projection (DLP) based devices; etc.

Variable wavelength light sources that may be used include two types of light sources: 1) light sources that can simultaneously emit a multiplicity of wavelengths combined with a spectrally tunable filter; or 2) discrete emission wavelength emitting light sources that are switched or tuned over time. An important design consideration for the light source is the power spectral density (W/Hz or W/nm). The power spectral density should be sufficiently large to satisfy at least two requirements. First, the spectral width (nm) of each emission wavelength should be sufficiently narrow so that the polarization state incident on the sample is nearly constant as represented, for example, on the Poincare sphere. Second, for a selected spectral width (nm), the source light must have sufficient power (mW) so that a small polarization change by the specimen can be detected with a signal to noise ratio larger than unity. These two requirements constrain the light source to have a relatively large power spectral density. Light sources with a power spectral density of about 1 mW/nm can satisfy these two requirements. For sources of the first type that emit a multiplicity of wavelengths simultaneously, a tunable spectral filter (e.g., monochromator, Fabry-Perot filter, acousto-optic filter, or filter wheel) may be used to select specific emission wavelengths. Light sources that simultaneously emit a multiplicity of wavelengths include supercontinuum sources, arc lamps, and light emitting diodes (LEDs). For laser sources that switch emission wavelengths, an exemplary embodiment would be a rapidly tunable laser or light source composed of multiple diode laser elements that are combined in for example a multimode optical fiber. The purpose of the multimode fiber is to spatially decorrelate or render light spatially incoherent. An exemplary variable wavelength light source that uses a lamp and tunable filter is the OL490 Agile Light Source from Optronic Laboratories (Orlando, Fla.). Similarly, a bright green LED in combination with a tunable spectral filter can serve as a light source. Exemplary supercontinuum sources are manufactured by NKT. An acousto-optic filter can be used to rapidly select a narrow band (1-5 nm) of spectral emission. Since the light emitted by the supercontinuum source has a high degree of spatial coherence, light may be coupled into a multimode fiber to provide spatially incoherent light incident on the sample. An exemplary light source that uses discrete laser diodes that are combined using dichroic elements is manufactured by Lumencor (Beaverton, Oreg.). Tunable laser sources may also be used. In this embodiment, a laser source with a gain media that covers the spectral range of interest, and includes a tunable element in the laser cavity. The various light emission wavelengths are selected by the tunable element in the laser cavity. Light emitted by the tunable laser is coupled into a multimode optical fiber to reduce spatial coherence. Alternatively, light emitted by a tunable laser (e.g., 1000-1100 nm) may be amplified and then converted through a non-linear optical interaction (e.g., frequency doubling or parametric conversion) to a shorter wavelength (e.g., 500-550 nm). In this approach the non-linear conversion process must be efficient over the desired spectral range of light incident on the specimen.

Polarization microscope 100 includes a first polarizer 120 having a first polarization axis. First polarizer 120 is optically coupled to variable wavelength light source 110, and thus functions as the polarizer for the light source. First polarizer 120 receives light from the variable wavelength light source and converts the light into linear polarized light having an orientation equal to the first polarization axis (arbitrarily depicted in FIG. 1). First polarizer 120 may be a polarizing prism whose performance, preferably, does not depend on the wavelength of incoming light. Examples of polarizing prisms include, but are not limited to, Glan-Thompson prisms, Glan-Taylor prisms, and Glan-Foucault prisms. A second polarizer 160, having a second polarization axis (arbitrarily depicted in FIG. 1), functions as the analyzer. Second polarizer 160 is oriented such that the second polarization axis is orthogonal to the first polarization axis. Second polarizer 160 (analyzer) is also a wavelength independent polarizer. Second polarizer 160 may be a polarizing prism. Preferably, first polarizer 120 and second polarizer 160 are matched polarizers having similar construction and optical properties so that their polarimetric extinction is large (e.g., 10⁵-10⁶).

Between first polarizer 120 and second polarizer 160 are two light retarders 130, 150. A first retarder 130 is optically coupled to first polarizer 120. Second retarder 150 is an opposite-signed retarder with respect to the first retarder. In one embodiment, the retarders are rotators (a circular retarder) that cause a phase delay between left and right circular polarized light. In another embodiment, an optical element composed of a rotator (circular retarder) and a waveplate (linear retarder) may be used as an elliptical retarder. In another embodiment, an optical element composed of two waveplates oriented at 45 degrees, with respect to each other, may be used as an elliptical retarder.

In one embodiment, retarders may be crystal polarized light rotators fabricated from quartz or TeO₂ crystals. In an embodiment, the crystal polarized light rotators are formed from left and right rotating version of TeO₂ crystals. Crystal polarized light rotators may rotate linearly polarized light independent of the angular orientation of the crystal such that circularly polarized light remains circularly polarized. The angle of rotation (Δφ) by the crystal polarized light rotator about the pole on the Poincare sphere is a function of wavelength (X), thickness (d) and circular birefringence (Δη(λ)) of the rotator according to the equation below.

$$Δφ ( λ ) = \frac{2 π \cdot d \cdot Δ n ( λ )}{λ}$$

The first and second crystal polarized light rotators are matched light rotators (equivalent thickness (d) and circular birefringence (Δn(λ))) such that the rotation produced by the first rotator is cancelled by the second rotator.

Retarders may also be made from levo- and dextrorotatory optically active organic compounds (enantiomers), or enantiomorphs. Retarders may be made from fixed magnet or electromagnetic Faraday rotators. In some embodiments, retarders may be made from thin film polymeric coatings or from suitable nanopatterning of optically transparent materials.

Polarization microscope 100 also includes a specimen stage 140 optically coupled to first retarder 130. Specimen stage 140 holds a specimen in the optical pathway of the light received from first polarized light rotator. An optical capture system is optically coupled to the second polarizer (analyzer) 160 to capture light passing through the second polarizer. The optical capture system includes a detector and a processor. The detector may be a sufficiently fast, sensitive, and low noise charged coupled device or scientific CMOS camera. A suitable detector is the Orca Flash 4.0 from Hamamatsu Photonics K.K. (Japan). Preferably the detector should be capable of capturing up to 100 frames per second at a resolution of up to 2048×2048. Higher frame rates and resolution would also be acceptable.

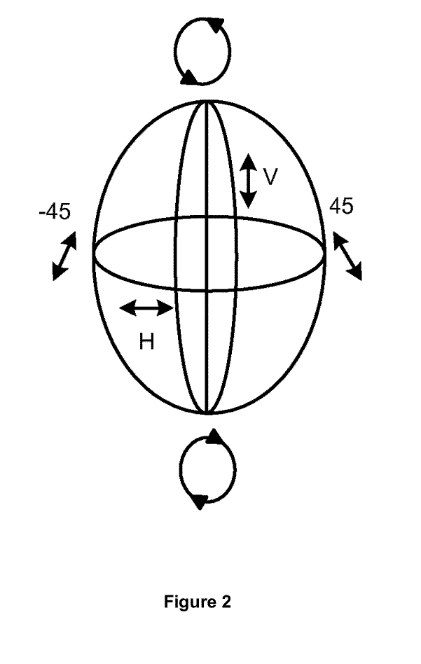

In the configuration of FIG. 1, as the wavelength from variable wavelength light source 110 is changed, linearly polarized light passing through first retarder 120 is rotated to a new polarization angle as a function of wavelength, such that changes in emission wavelength move the polarization state around the equator of the Poincare sphere (FIG. 2). The change in emission wavelength needs to be at least as large as the spectral width of the light source. Light then passes through the specimen where the polarization may be modified due to interaction with specimen (e.g. polarization changes due to scattering or birefringence). When the light passes through second retarder 150, the rotation (due to the first retarder) is reversed by an equal amount. If first polarizer 120 is oriented horizontally, after passing through second retarder 150, light will be returned to the horizontal polarization state (if the specimen does not modify the birefringence). Light then passes through the second polarizer (analyzer) 160 oriented vertically, which blocks horizontally polarized light that has not been altered due to birefringence of the specimen. This is the principle herein referred to as a “null measurement”.

The maximum light intensity produced by a linearly birefringent object is obtained when the plane of linearly polarized light is oriented 45° with respect to the axis of the birefringent object. Since these objects can be oriented at any arbitrary angle in the cell, one must rotate the polarization state of incident light on the Poincare sphere though an angle of at least 90° to realize the maximum birefringence light intensity signal. This 90° range of rotation can be achieved by recording images formed by light emitted from a variable wavelength source emitting shorter and longer wavelengths. For example for a TeO₂ crystal rotator, the rotation/mm thickness (Δφ/d) drops steeply over the 450-600 nm range. Thus by switching from a longer to shorter wavelength one can change the amount of rotation on the Poincaré sphere by more than 90°. Furthermore, as a TeO₂ crystal rotator gets thicker (d becomes larger), the wavelength range required to achieve a 90° rotation about the polar axis on the Poincaré sphere gets smaller while the variation of the polarization state over each emission wavelength range becomes larger.

In one embodiment, using the configuration shown in FIG. 1, a user can choose a series of preset wavelengths and record an image at each wavelength. In one embodiment, using a switching time on the order of 20 microseconds or slower, a user can easily switch wavelengths between recording each image. Processing the data may be accomplished using a single frequency Fourier filtering algorithm as set forth in Kuhn et al. “Modulated Polarization Microscopy: A Promising New Approach to Visualizing Cytoskeletal Dynamics in Living Cells” Biophysics Journal, 80 (2001) 972-985, which is incorporated herein by reference. Calibration may be necessary to keep the illumination intensity constant and to determine the exact rotation angle achieved for a given wavelength. In some embodiments, the variable wavelength light source will allow computer control of the illumination intensity. Determination of rotation angle may be done by using a rotating polarizer.

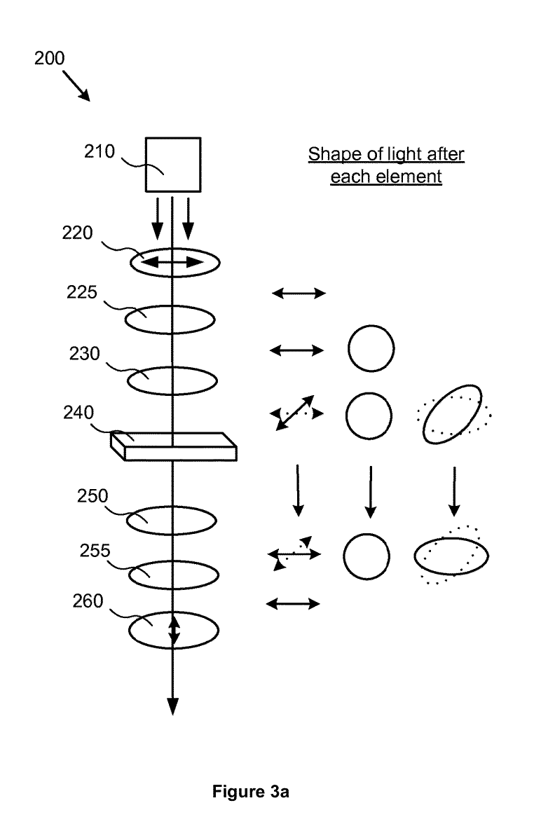

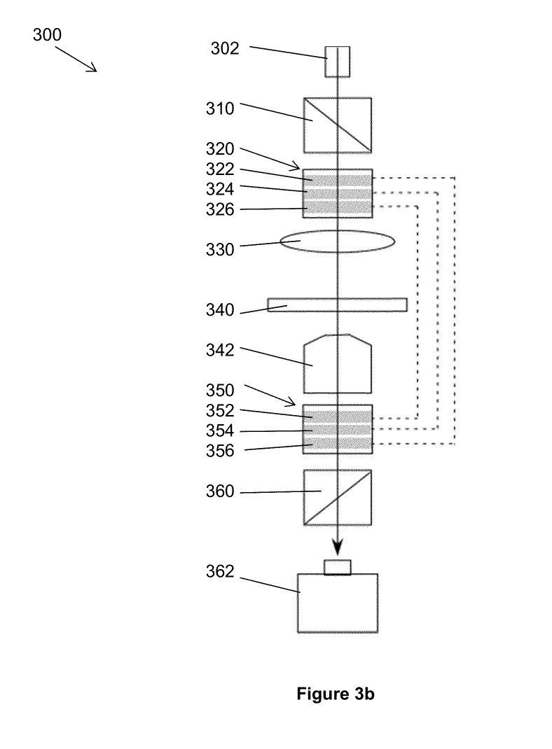

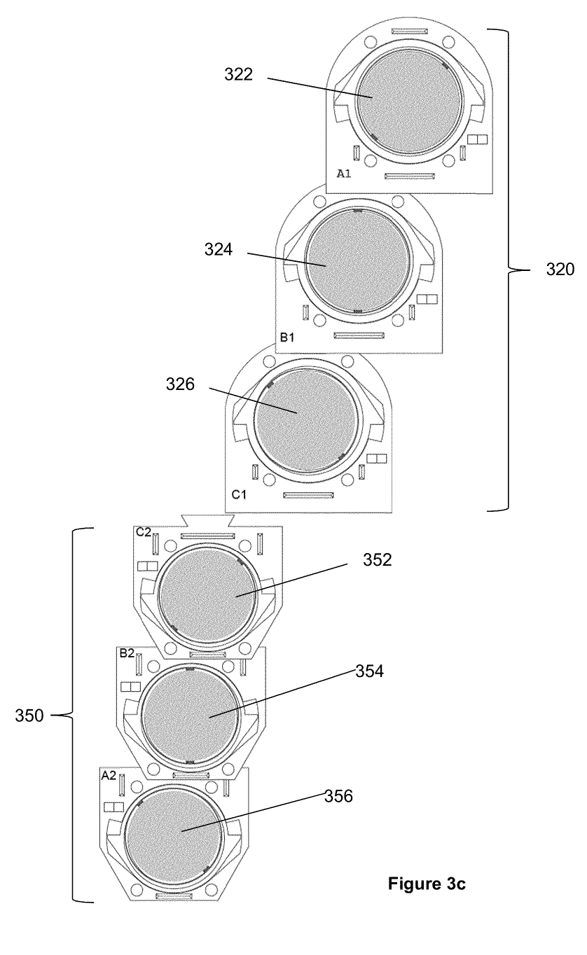

One of the problems with simply rotating linearly polarized light using a circular retarder is that one cannot measure and image circular or elliptical birefringent structures in the specimen. To measure arbitrary sample birefringence, it is necessary to present the specimen with both linearly and circularly polarized light or more generally elliptically polarized states. In an alternate embodiment, schematically depicted in FIG. 3a, the ability to present the specimen with both linearly, circularly and elliptically polarized light is added, while maintaining the ability to make a null measurement. The combination of a rotator and linear retarder produces various states of polarized light including linear, elliptical, and circular. In FIG. 3a, the retarder is an optical element that is composed of a rotator (circular retarder) and a waveplate (linear retarder). As depicted in FIG. 3a, first waveplate 225 is optically coupled to first polarizer 220 and the first rotator 230. First waveplate 225 receives polarized light from first polarizer 220 and converts incident linearly polarized light into circularly polarized light and elliptically polarized light. First waveplate 225 variously passes linearly, circularly, or elliptically polarized light (depending on the wavelength) to first rotator 230. First rotator 230 changes the orientation of the linearly or elliptically polarized light. A second waveplate 255 is optically coupled to second polarizer 260 and second rotator 250. Second waveplate 255 reverses the changes created by passage through first waveplate 225 by being oriented at 90 degrees to first waveplate 225. Second waveplate 255 receives circular or elliptically polarized light from second polarized light rotator 250 and converts the incident circular polarized light or elliptically polarized light into linearly polarized light. The linearly polarized light is passed to second rotator 250 which then rotates linear polarized light back to its original angle based on the first polarizer. In some embodiments, the waveplates are oriented at +45° and −45° with respect to the polarization axis of first polarizer 220. The waveplates may be made from any suitable birefringent material, such as quartz, mica, and polymers. The first and second waveplates are matched waveplates (equivalent thickness (d) and circular birefringence (Δn(λ))) such that the changes produced by the first waveplate is cancelled by the second waveplate.

Another embodiment of the inverted microscope 300 is shown in FIG. 3B. An incoming light source is optically coupled to a First polarizer 310. Incoming light source could be any sufficiently bright light source that can switch between or otherwise deliver a set of desired wavelengths. This could include broadband sources such as from an arc lamp, a set of laser sources or a tunable laser source. The polarizers ideally are of high quality and provide high extinction (10⁵-10⁶). They can be selected from crystal polarizers including calcite or a-barium borate, film polarizers, stretched glass polarizers or any device that produces polarized light. A First retarder module 320 receives polarized light from the first polarizer 310, and the First retarder module 320 comprises a first Quartz retarder 322, a Second Quartz retarder 324, and a first ¼ wave plate 326. The retarder module 320 includes one or more linear retarders and/or polarization rotators that can be made from crystalline materials such as quartz, TeO2 or other materials. The first retarder module 320 is shown in FIG. 3C. The first retarder module 320 is operably coupled to a Condenser 330 which receives light exiting the first retarder module 320. The Condenser 330 is a lens is strain free and non-birefringent, in one embodiment. The Condenser 330 then sends light to a Specimen 340. After the Specimen 340, light exits to an Objective lens 342. Objective lens is ideally strain free and non-birefringent. The objective lens 342 then sends light to a Second retarder module 350. The Second retarder module 350 comprises a second ¼ wave plate 352, a third quartz retarder 354, and fourth quartz retarder 356. As shown in FIG. 3c, the second retarder module 350 consists of a series of retarders and or retarders that are matched in thickness, orientation, and optical retardation to those of the first retarder module such that first quartz retarder is matched to the fourth quartz retarder 356, the second quartz retarder 324 is matched to the third quartz retarder 354 and the first ¼ wave plate 326 is matched to second zero order ¼ wave plate 352. In the second retarder module 350, the fast and slow axes of each retarder are opposite to those of the corresponding retarder in the first retarder module 320. In one embodiment, the first ¼ wave plate 326 and the second ¼ wave plate 352 are zero order retarders. The second polarizer is similar to the first polarizer except that it is rotated either exactly 90 degrees or 90 degrees + or − a small increment relative to the first polarizers. From the second retarder module 350, light enters a second polarizer 360 and then to a camera detector 362. In one embodiment, the first retarder is a 4.25 wave at 525 nm wave retarder, the second retarder is a 12.75 wave at 525 nm wave retarder, and the first wave plate is a zero order retarder at 525 nm. In one embodiment, the zero order retarders are two retarders fixed together to give a difference of ¼ wavelength.

There is trade-off between the spectral width at a given setting and the variation in the polarization over that spectral width—which is a polarimetric dispersion issue—as discussed previously. The power spectral density of the light source should be sufficiently bright so that the spectral width of each wavelength step can be narrow enough to simultaneously provide enough light on the specimen for small polarization changes and the polarimetric dispersion to be small enough to give a pure enough polarization state to detect the change produced by the specimen.

Whereas, the polarization rotators (circular retarders) rotate the polarization state about the polar axis of the Poincaré sphere (as a function of wavelength) to give polarized light rotated at different angles, the effect of the waveplates is to rotate the polarization state about an equatorial axis on the Poincaré sphere. Action of the linear and circular retarder together, as the wavelength is changed, allow the polarization state to produce both azimuthal (about the poles) and longitudinal (about an equatorial axis) movement on the Poincaré sphere and spiral around the Poincaré sphere as it moves from one pole to the other. The total retardation and thus circularity of the polarization will be a function of wavelength and the thickness of the waveplates. For example, an approximately 0.5 mm thick quartz waveplate that retards 9.25λ at 500 nm will retard 8.5λ at 539.6 nm and 11.25λ at 420.9 nm. Given that one cannot detect retardations of full wavelengths, we can arbitrarily refer to a 9λ waveplate for a given wavelength as retarding 0 at that wavelength. Therefore, at 500 nm a 9.25 waveplate is effectively a quarter wave plate. What can be seen then is that in moving from 539 nm (8.5λ retardation) to 500 nm (9.25λ retardation), the retardation changes from ½λ to ¾λ to 0 to ¼λ. Notably at ½λ and 0λ light is plane polarized whereas at ¾λ and ¼λ we have left and right circularly polarized light respectively. On the Poincaré sphere, changing from left to right circularly polarized light is represented by moving from one pole to the other. For wavelengths between those giving circular or linear polarization we would have elliptically polarized light with varying degrees of ellipticity. After light passes through the specimen, the remaining crystal rotator and waveplate reverse the polarization state back to linear polarized light oriented horizontally. The result is that in the absence of specimen birefringence, the field is dark. Thus this arrangement once again provides for a null measurement.

The optical elements in the microscope depicted in FIG. 3a can be each represented by a Jones matrix (Table 1) and when multiplied appropriately the matrices show the changes in polarization state as light passes through each element of the optical train. The polarization state was examined for several wavelengths with respect to the retardation plates, to give retardations of 0, 22.5 (⅛λ), and 45° (¼λ). The results show that, regardless of the wavelength of illumination, after the last retarder, the light is horizontally polarized giving a null measurement.

TABLE 1
Wavelength Dependent Retardation

| | 0° | | 22.5° | | 45° | |
|---|---|---|---|---|---|---|
| Horizontal | 1 | 0 | 1 | 0 | 1 | 0 |
| Polarizer | 0 | 0 | 0 | 0 | 0 | 0 |
| Waveplate | 1 | 0 | .938 | 0 | .707 | 0 |
| (45°) | 0 | 0 | .346i | 0 | .707i | 0 |
| Rotator (L) | .707 | 0 | .663 + .245i | 0 | .5 + .5i | 0 |
| | −.707 | 0 | −.663 + .245i | 0 | −.5 + .5i | 0 |
| Rotator (R) | 1 | 0 | .938 | 0 | .707 | 0 |
| | 0 | 0 | .346i | 0 | .707i | 0 |
| Waveplate | 1 | 0 | 1 | 0 | 1 | 0 |
| (−45°) | 0 | 0 | 0 | 0 | 0 | 0 |
| Vertical | 0 | 0 | 0 | 0 | 0 | 0 |
| Polarizer | 0 | 0 | 0 | 0 | 0 | 0 |

The rationale for using a null measurement is that it allows for detection of weak signals without large swings in brightness of the background illumination. If, for example, one were viewing circularly polarized light through a linear polarizer the image would be very bright. On the other hand when viewing weak birefringence between crossed polarizers, the image would be relatively dim. To do both, it is desirable to limit the brightness of the illumination so that the brightest image is on scale. This in turn limits the sensitivity of the camera to the weak signals needed to detect. With a null measurement, the brightness of illumination is limited by the brightness of the weakly birefringent signals.

For detection of polarization changes of various forms, linearly polarized light (0°) at wavelength (λᵢ) is transformed to a pre-calibrated elliptical polarization state after propagation through a waveplate (45°)/rotator (θ) combination (FIG. 3). Elliptically polarized light is incident on the sample after propagating through the condenser. The Poincaré sphere is utilized to analyze the polarization transformations in the microscope with an arbitrary polarization state denoted by azimuthal (φ) and polar (θ) angles on a sphere with radius 1. For illustration, we consider an arbitrary elliptical sample birefringence (i.e., linear and circular birefringence) specified by (φₒ, θₒ) with phase retardation δᵢ at wavelength λᵢ. For a null measurement, sample positions with non-zero birefringence give a signal intensity (Sᵢ) at wavelength λᵢ that is proportional to square of phase retardation (δᵢ), where (φₒ, θₒ) specifies orientation of the sample birefringence axis relative to the polarization state of light incident on the sample at λₒ and λφᵢ, Δθᵢ, are orthogonal transformations on the Poincaré sphere that map the polarization state incident on the sample at wavelength Δᵢ into the reference state at wavelength λₒ.

$${S}_{o} = \frac{1}{4} {δ}_{0}^{2} ( {sin}^{2} ( {θ}_{a} ) \cdot {sin}^{2} ( {φ}_{o} ) + {cos}^{2} ( {θ}_{o} ) )$$

$${S}_{1} = \frac{1}{4} {( \frac{{δ}_{0} \cdot {λ}_{0}}{{λ}_{1}} )}^{2} ( {sin}^{2} ( {θ}_{o} + {Δθ}_{1} ) \cdot {sin}^{2} ( {φ}_{o} + {Δφ}_{1} ) + {cos}^{2} ( {θ}_{o} + {Δθ}_{1} ) )$$

$${S}_{2} = \frac{1}{4} {( \frac{{δ}_{0} \cdot {λ}_{0}}{{λ}_{2}} )}^{2} ( {sin}^{2} ( {θ}_{o} + {Δθ}_{2} ) \cdot {sin}^{2} ( {φ}_{o} + {Δφ}_{2} ) + {cos}^{2} ( {θ}_{o} + {Δθ}_{2} ) )$$

$$⋮$$

$${S}_{n} = \frac{1}{4} {( \frac{{δ}_{0} \cdot {λ}_{0}}{{λ}_{n}} )}^{2} ( {sin}^{2} ( {θ}_{o} + {Δθ}_{n} ) \cdot {sin}^{2} ( {φ}_{o} + {Δφ}_{n} ) + {cos}^{2} ( {θ}_{o} + {Δθ}_{n} ) )$$

These equations elucidate a problem with carrying out a null measurement. Because the signal intensity (S) is proportional to the square of the specimen phase retardation (δ²), the sign of δ cannot be determined—or equivalently the direction of the birefringence axis is degenerate. When the sign of δ (positive or negative birefringence) is determined using a non-null measurement, as we show below, one can gain an 11-fold improvement in signal to noise.

In the proposed non-null measurement, the polarizer is misaligned from the analyzer by a small angle so that after propagating through the sample and rotator-retarder combination, polarization state (αᵢ, βᵢ) of light incident on the analyzer at each wavelength (λᵢ) is slightly offset from the horizontal polarization state (α=0, β=π/2). In the case of a non-null measurement, the signal intensity (Sᵢ) for each wavelength (λᵢ) is:

$${S}_{0} = \frac{1}{2} \cdot [ \begin{matrix}1 - sin ( {β}_{0} ) cos ( {α}_{0} ) + {δ}_{0} ( cos ( {θ}_{0} ) sin ( {α}_{0} ) sin ( {β}_{0} ) - sin ( {θ}_{0} ) sin ( {ϕ}_{0} ) cos ( {β}_{0} ) ) + \\ {δ}_{0}^{2} / 2 ( \begin{matrix}cos ( {α}_{0} ) sin ( {β}_{0} ) - {sin}^{2} ( {θ}_{0} ) cos ( {ϕ}_{0} ) sin ( {β}_{0} ) cos ( {ϕ}_{0} - {α}_{1} ) - \\ sin ( {θ}_{0} ) cos ( {θ}_{0} ) cos ( {ϕ}_{0} ) cos ( {β}_{0} )\end{matrix} )\end{matrix} ]$$

$${S}_{1} = \frac{1}{2} \cdot [ \begin{matrix}\begin{matrix}1 - sin ( {β}_{1} ) cos ( {α}_{1} ) + \\ ( {δ}_{0} \cdot {λ}_{0} / {λ}_{1} ) ( cos ( {θ}_{0} + {Δθ}_{1} ) sin ( {α}_{1} ) sin ( {β}_{1} ) - sin ( {θ}_{0} + {Δθ}_{1} ) sin ( {ϕ}_{0} + {Δϕ}_{1} ) cos ( {β}_{1} ) ) +\end{matrix} \\ {( {δ}_{0} \cdot {λ}_{0} / {λ}_{1} )}^{2} / 2 ( \begin{matrix}cos ( {α}_{1} ) sin ( {β}_{1} ) - {sin}^{2} ( {θ}_{0} + {Δθ}_{1} ) cos ( {ϕ}_{0} + {Δϕ}_{1} ) sin ( {β}_{1} ) cos ( {ϕ}_{0} + {Δϕ}_{1} - {α}_{1} ) - \\ sin ( {θ}_{0} + {Δθ}_{1} ) cos ( {θ}_{0} + {Δθ}_{1 } ) cos ( {ϕ}_{0} + {Δϕ}_{1} ) cos ( {β}_{1} )\end{matrix} )\end{matrix} ]$$

$${S}_{2} = \frac{1}{2} \cdot [ \begin{matrix}\begin{matrix}1 - sin ( {β}_{2} ) cos ( {α}_{2} ) + \\ ( {δ}_{0} \cdot {λ}_{0} / {λ}_{2} ) ( cos ( {θ}_{0} + {Δθ}_{2} ) sin ( {α}_{2} ) sin ( {β}_{2} ) - sin ( {θ}_{0} + {Δθ}_{2} ) sin ( {ϕ}_{0} + {Δϕ}_{2} ) cos ( {β}_{2} ) ) +\end{matrix} \\ {( {δ}_{0} \cdot {λ}_{0} / {λ}_{2} )}^{2} / 2 ( \begin{matrix}cos ( {α}_{2} ) sin ( {β}_{2} ) - {sin}^{2} ( {θ}_{0} + {Δθ}_{2} ) cos ( {ϕ}_{0} + {Δϕ}_{2} ) sin ( {β}_{2} ) cos ( {ϕ}_{0} + {Δϕ}_{2} - {α}_{2} ) - \\ sin ( {θ}_{0} + {Δθ}_{2} ) cos ( {θ}_{0} + {Δθ}_{2 } ) cos ( {ϕ}_{0} + {Δϕ}_{2} ) cos ( {β}_{2} )\end{matrix} )\end{matrix} ]$$

$$⋮$$

$${S}_{n} = \frac{1}{2} \cdot [ \begin{matrix}\begin{matrix}1 - sin ( {β}_{n} ) cos ( {α}_{n} ) + \\ ( {δ}_{0} \cdot {λ}_{0} / {λ}_{n} ) ( cos ( {θ}_{0} + {Δθ}_{n} ) sin ( {α}_{n} ) sin ( {β}_{n} ) - sin ( {θ}_{0} + {Δθ}_{n} ) sin ( {ϕ}_{0} + {Δϕ}_{n} ) cos ( {β}_{n} ) ) +\end{matrix} \\ {( {δ}_{0} \cdot {λ}_{0} / {λ}_{2} )}^{2} / 2 ( \begin{matrix}cos ( {α}_{n} ) sin ( {β}_{n} ) - {sin}^{2} ( {θ}_{0} + {Δθ}_{n} ) cos ( {ϕ}_{0} + {Δϕ}_{n} ) sin ( {β}_{n} ) cos ( {ϕ}_{0} + {Δϕ}_{n} - {α}_{n} ) - \\ sin ( {θ}_{0} + {Δθ}_{n} ) cos ( {θ}_{0} + {Δθ}_{n } ) cos ( {ϕ}_{0} + {Δϕ}_{n} ) cos ( {β}_{n} )\end{matrix} )\end{matrix} ]$$

The set of nonlinear equations for the non-null measurement must be solved to determine three parameters—phase retardation (δₒ) and axes of birefringence (φₒ, θₒ). The ratio of circular to linear birefringence (Δn_{circ}/Δnₗᵢₙ) is given by Δn_{circ}/Δnₗᵢₙ=tan(θₒ) while direction of the sample's linear birefringence in the laboratory frame is given by 2φₒ. For example if N incident wavelengths (λᵢ) are utilized, then real-time imaging requires computation of these three parameters at four-million pixels in N/F seconds where F is the camera frame rate in Hz. When N=7 and F=100, then this time is N/F=0.07 seconds. We have shown that a single Radeon R9-290 graphics card can process data at the required rate. Given the number of camera pixels (for example 2048×2048) recording signal intensity (Sᵢ) data at seven wavelengths, the amount of data that must be processed by the video card to compute one phase retardation and birefringence images is 2.8×10⁷ samples. So, there are about 15,000 FLOPs per pixel to solve the non-null equations. An optimized Levenberg-Marquardt algorithm, for example, may be utilized to solve the signal intensity equations to provide real-time images of the birefringence properties of the specimen at each pixel location.

Equations for the signal intensity (Sᵢ) at each wavelength contain terms that should be calibrated, including: the non-null state (αᵢ, βᵢ) at each wavelength λᵢ and the orthogonal transformations (Δφᵢ, Δθᵢ) on the Poincaré sphere that relate or map the polarization state incident on the sample at wavelength λᵢ into the reference state at wavelength λₒ. For the calibrations, the goal is to determine the input state for light incident on the specimen so the second crystal rotator and the second waveplate will be removed from the path. In one embodiment, polarization analyzers use a rotating ¼ wave plate. In one embodiment, the input state of the second polarizer (analyzer) may be determined by rotating the polarizer through discrete angles by mounting it on a motor-driven rotary stage (e.g., a Picometer, Newport AG-PR100, Newport Corporation, Irvine, Calif.) placed either in the second turret position or before the camera. Images obtained as the polarizer is rotated will used for the pixel-by-pixel determination of ellipticity (tan(X_{i,j})) and orientation (Ψ_{i,j}) of the major axis of the polarization ellipse. Other methods known in the art of light polarization may be used for determining the input polarization state of light. For circular polarization, the handedness should be obvious from the input state but it could also be easily determined by repeating the rotating analyzer measurement with an added achromatic λ/4 plate and determining the axis of the resulting linear polarized state. Each of these terms will be calibrated and fixed during operation of the microscope. One useful feature of the graphics cards is that they can be obtained with large amounts of memory for storing image data. These calibration images take into account and ultimately compensate for aberrations in the lenses that alter the polarization state.

For samples that exhibit rapid movements, current capabilities allow recording polarized light images at 100 frames/second with a 4 megapixel camera. In a previous modulated polarization microscope (FIG. 1), we made null measurements from data recorded at 30 frames/second using an analog camera and a relatively weak light source. Even so, there was more than enough light. Since we could conceivably bin pixels to the equal that of the analog camera, it may be possible to find a point where there is enough light. However, the signal-to-noise depends on the brightness of the illuminating spot on the specimen.

In employing a non-null measurement, where the polarizers are not exactly crossed, the amount of light to the detector is increased. Furthermore, a non-null measurement actually increases the signal-to-noise by adding a signal term that is linear in phase retardation (δ). In the non-null case, the SNRₗᵢₙₑₐᵣ is given by,

$${SNR}_{linear} = \sqrt{{N}_{o} T} \frac{\vert δ ( cos ( {θ}_{o} ) sin ( α ) sin ( β ) - sin ( {θ}_{o} ) sin ( {ϕ}_{o} ) cos ( β ) ) \vert}{\sqrt{1 - sin ( β ) cos ( α )}} .$$

Based on the above equation, SNR can be increased by using a brighter light source.

One possible effect of the approach as described above is that the spectral range of wavelengths needed to obtain all spectral measurements is broad enough to introduce artifacts into the data. These artifacts include differences in resolution, differential scattering, and differences in absorption. Therefore, it is desirable to minimize the wavelength range needed to obtain all spectral (e.g., 7) measurements. Our data show that a spectral bandwidth of 5 nm or less for each wavelength is adequate for accurate calculation of specimen birefringence. Larger spectral bandwidths lead to less accuracy. Better accuracy may be achieved by using narrower bandwidths together with light sources with greater power spectral densities. This may be accomplished, for example, by using laser illumination where the spectral emission bandwidth (nm) of individual laser lines is on the order of 2 nm. Given the narrow bandwidth of laser illumination one could obtain all 7 measurements over a wavelength range of less than 20 nm. This narrow range of wavelengths mitigates against detectable differences in resolution, scattering or absorption.

The use of a narrow range of emission wavelengths, such as that provided by a laser source, is preferred when the objective is to provide the added capability of imaging the same specimen by polarized light or by fluorescence. The bright illumination provided by the polarized light source can bleach fluorescent molecules that absorb in the wavelengths used for polarized light imaging. The use of a narrow range of wavelengths for polarized light imaging allows for fluorescence imaging of molecules whose absorption spectrum lies outside the wavelengths used for polarized light imaging.

An additional capability the proposed polarization microscopy approach allows is structured illumination at each spectral emission wavelength. Some of the radiant sources (e.g. lasers), radiant emission can be separated into discrete emitters such as optical fibers that are positioned in the front plane of the condenser lens. By positioning the discrete emitters in the front focal plane of the condenser lens, the angle of incident radiation on the specimen may be controlled. Light emission from each of the discrete emitters can be shuttered with for example a MEMS switch so that any combination of incident light angles on the sample can be obtained at each wavelength. This approach allows for polarization microscopy with super-resolution. Although super-resolution microscopy approaches are known in the art, the combination of spectrally-encoded high-extinction polarization microscopy with super-resolution provides a number of unique capabilities. Alternative approaches to multiple discrete fibers may be utilized to control the spatial illumination of light incident on the specimen. For example, a DLP chip can be positioned or imaged to the front focal plane of the condenser lens to control the angle of illumination on the specimen.

In order to reap the full power of polarized light imaging, it may be useful to identify particular molecules and structures. As a consequence, either embodiment of the polarization microscope may have the capability of fluorescence imaging. In an embodiment, the optical polarizers, waveplates and rotators are compact and can be rapidly moved in and out of the optical path to allow the introduction of fluorescent imaging optical components (e.g. a dichroic mirror and suitable filter) into the optical pathway. In one embodiment, the polarization optical components can fit into the place of a dichroic filter set in microscopes designed to hold multiple dichroic filter sets. This can allow the use of the standard epifluorescence light path in, for example, the Nikon Eclipse Ti inverted microscope. The fluorescence illumination in this case is simply turned on or off through a shutter. Alternatively, rather than have a separate light source for fluorescence illumination, a switching mirror (e.g., available from Newport Corporation, Irvine Calif.) may be used to feed two alternative light paths, one for fluorescence excitation and one for transmitted (polarized) light. These may be switched according to which mode of imaging is desired by the microscope user.

Alternatively, one light source such as that provided by a series of lasers can be used for polarized light imaging and a second broad band light source (lamp or supercontinuum) can be used for fluorescence. Here the laser-based source would enter the vertical light or transmitted light path whereas as the broadband source would illuminate the standard epifluorescence light path (typically through the rear of the microscope). Suitable controls such as shutters or power input into the laser would allow for alternating the illumination between the sources. The camera, which may be mounted under the microscope in a linear path, may be used to collect both polarized light and fluorescence images. Alternatively two different cameras might be employed by diverting the output from one port of the microscope to another.

The use of a narrow band (or closely spaced set) of spectral emission wavelengths for polarized light imaging allows for some flexibility for choosing what band will be used. The same optics may be used for different spectral emission wavelengths but the system would is pre-calibrated (as described above) for each set of wavelengths. Alternatively, the user could employ different retarders and rotators for different wavelength bands so as to tune the configuration. In either case, the use of particular wavelength bands allows for polarized light imaging at a set of spectral emission wavelengths that avoids exciting and thus bleaching fluororphores outside the wavelength band used for polarized light imaging. The diameter of the quartz retarders does not limit the aperture as to limit the resolution of the polarization microscope.

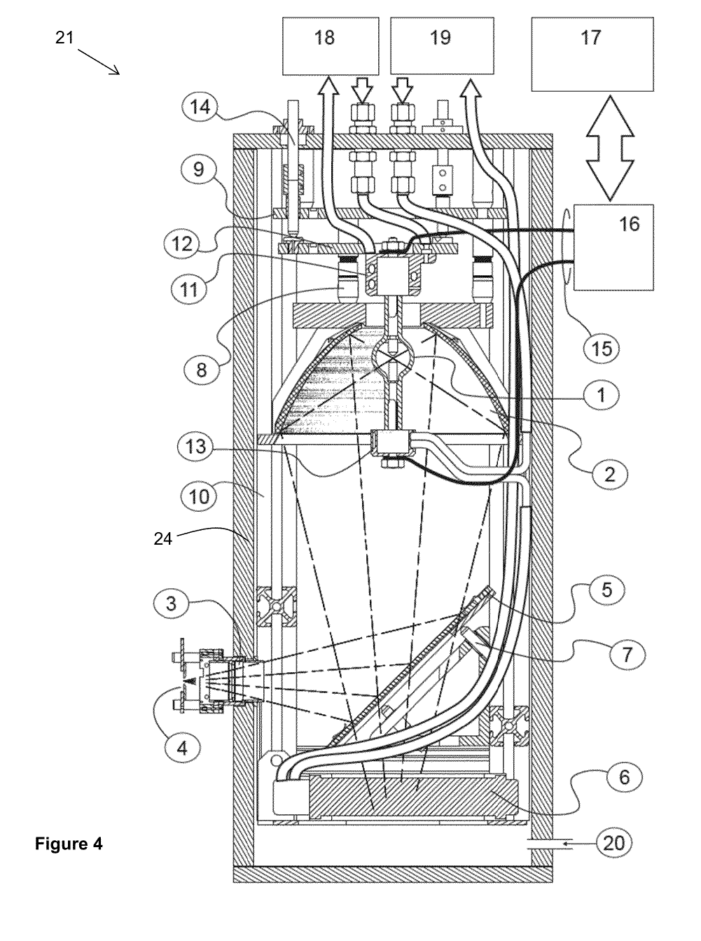

In one embodiment, the light source is depicted in FIG. 4 as a lamp housing 21. The lamp housing 21 comprises a xenon arc lamp 1 that illuminates an ellipsoidal mirror 2 focused through an ultraviolet-blocking window 3 onto an exit slit 4. A xenon arc lamp is a specialized type of gas discharge lamp, an electric light that produces light by passing electricity through ionized xenon gas at high pressure. It produces a bright white light that closely mimics natural sunlight at 10,000K. Xenon arc lamps can be a continuous-output xenon short-arc lamps or a continuous-output xenon long-arc lamps.

The infrared wavelengths from the exit slit 4 pass through a flat mirror 5 onto a beam block 6. In one embodiment, the beam block 6 may be water cooled or cooled by another type of cooling mechanism, such as a coolant, fan, refrigerant and the like. The flat mirror 5 is adjustable and in one embodiment, the flat mirror 5 is adjustable through a plurality of screws 7 and the ellipsoidal mirror 2 adjusted through a plurality of posts 8 in reference to a plate 9 and an internal frame 10. The arc lamp anode is attached to a cooler 11 and a ceramic insulating plate 12. The arc lamp cathode is connected to a cooler 13. Anode position adjustment screws 14 pass through the air-tight housing 24 to position the arc lamp 1. Anode and cathode high-voltage connections 15 pass through the case to an external igniter 16 and a power supply 17. Anode coolant lines pass through the case to an external anode radiator and water pump 18. Cathode and beam block coolant lines are connected to a separate radiator and a water pump 19. The housing 24 is filled with a gas through gas line 20. In one embodiment, the gas may be nitrogen.

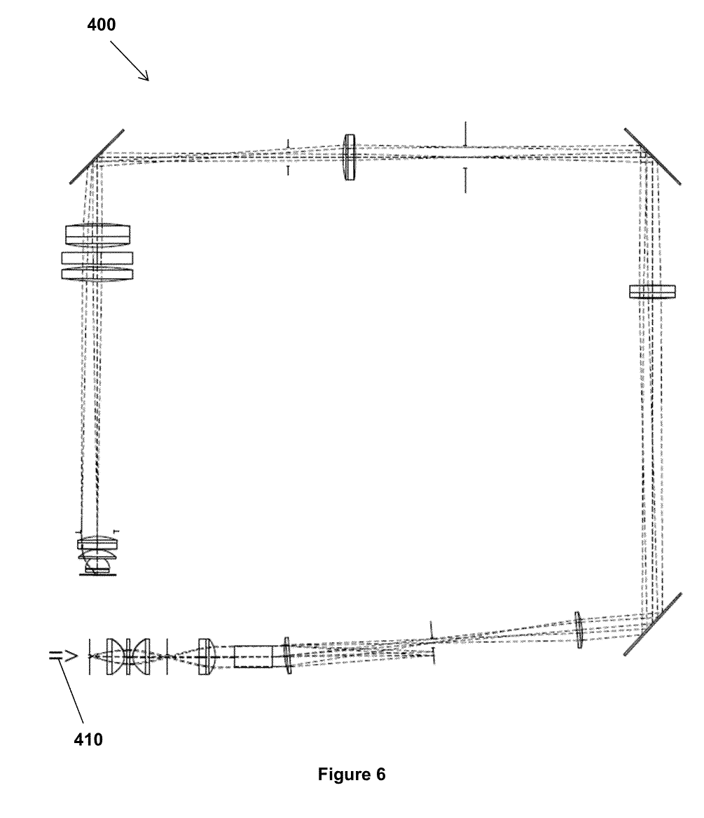

The microscope optical train 400 diagram is shown in FIG. 6. The optical path at the bottom has been flipped 180 degrees (around the mirror). The light comes from the light source 410 from the right side and then is reflected upwards into the microscope.

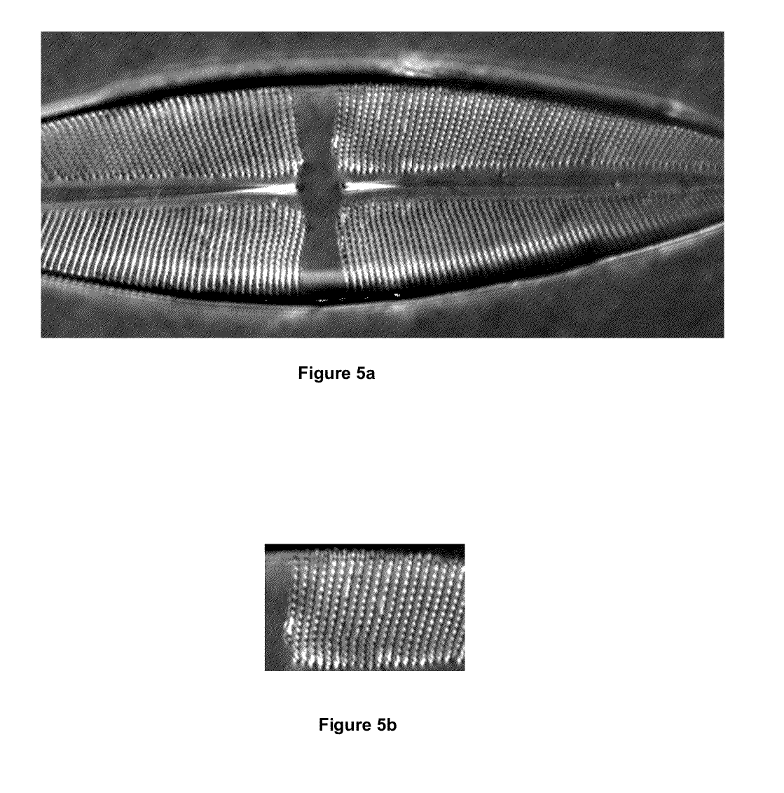

Birefringence images of a diatom (lower and higher magnification views in FIGS. 5a and 5b) obtained with the microscope. The height of the higher magnification image in FIG. 5a is about 4 microns.

The disclosed polarization microscope may be used to study biological events as they occur. For example, the novel polarization microscope may be used to study cytoskeletal dynamics in living cells. In one example, polarized light imaging has facilitated understanding of how T cells function. Helper and cytotoxic T cells function by directed and focused secretion of molecules towards another cell. This is largely accomplished by movement of the microtubule organizing center (MTOC) up to the site of contact between a T cell and its cognate target and focusing of secretory vesicles around the MTOC. In an embodiment, modulated polarization microscopy may be used to follow microtubules and the MTOC as well as secretory vesicles in T cells. The MTOC organizes the microtubule cytoskeleton in T cells. In cytotoxic T cells, for example, the CTL engages a target cell and signaling through the T cell receptor leads to T cell activation. This leads to a dramatic reorganization of surface molecules at the target contact site as well as the underlying cytoskeleton. These rearrangements define what is termed the immunological synapse. At some point during synapse formation, the MTOC is drawn up to the synapse. Either before or after MTOC movement, secretory vesicles move along microtubules towards the MTOC where they concentrated. This combination of MTOC translocation and secretory vesicle movements ultimately concentrates secretory vesicles at the synapse where they are secreted. Understanding the mechanism of MTOC translocation is critical because it lies at the heart of T cell effector functions. Furthermore, studies have shown that factors in the tumor environment can block MTOC translocation despite the fact that T cells activate. This can lead to tumor escape.

Specific applications of the polarized microscopes disclosed herein include visualization of the cytoskeleton, visualization of vesicles, membranes, cell organelles, viral particles and organized protein assemblies such as collagen. All of these structures can now be visualized in real time. Polarized light microscopy also can enable the visualization of molecular interactions. Nanorods should be visible based on their interaction with polarized light. Nanospheres, although invisible as monomers, would become visible when dimerized. As labels for individual proteins or receptors, dimerization might be detected when two labeled proteins come together in a binding reaction or when cross-linked by other means.

Gold nanoparticles have tremendous potential as labels because as light scatterers, they are orders of magnitude brighter than fluorophores and they do not bleach. Thus one can easily image individual gold nanoparticles. Furthermore, molecule binding events can shift the emission, typically to longer wavelengths. In addition, using polarized light imaging, there is a difference between spherical and rod-shaped nanoparticles or when two spherical nanoparticles come close together. Rod shaped particles depolarize the illumination and exhibit anisotropy whereas individual spherical nanoparticles do not. However, when two spherical nanoparticles come together, with respect to polarized light they behave light rods and exhibit anisotropy. Thus individual molecules tagged with small nanoparticles may be imaged to determine if they are bound or free.

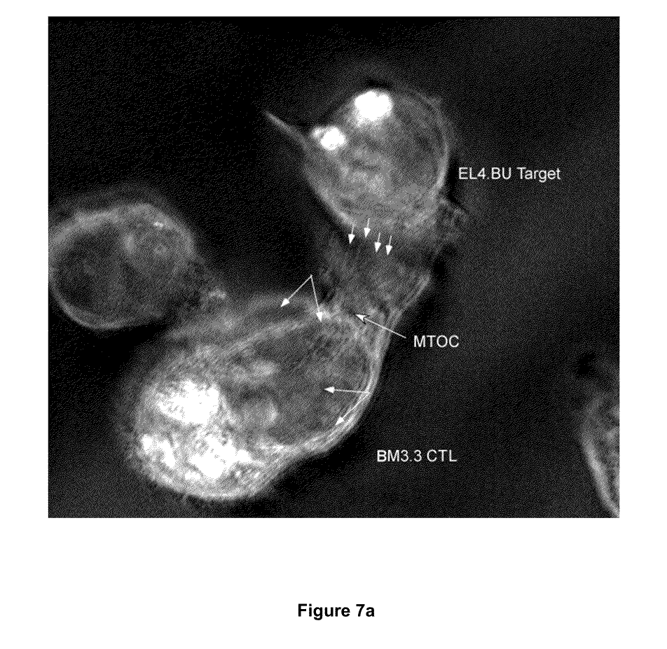

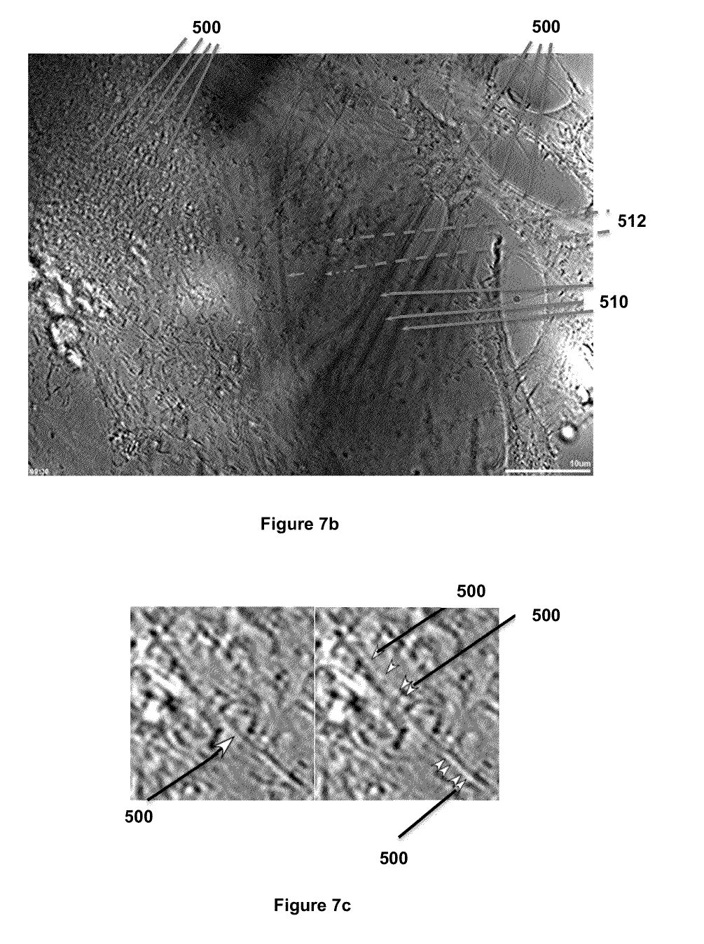

FIG. 7a is an image using the polarization microscope showing a BM3.3 T cell attacking a target. The microtubules are pointed out with arrows. BM3.3 is a cytotoxic T cell line that is shown interacting with an EL4 lymphoma cell. The microtubules and microtubule organizing center (MTOC) are evident (arrows) despite the fact that this is a rapidly moving cell.

Vesicles and MT

FIG. 7b is an image using the current microscope showing microtubules 500 and actin-based stress fibers 510 with blue arrows. A stress fiber 510 in the process of disintegrating is shown with a dashed arrow.

FIG. 7c is an image using the current microscope showing a small region of a 3T3 fibroblast cell that includes a microtubule 500 decorated with numerous small vesicles in the left panel. Some of these vesicles have diameters on the same order as the microtubule (25 nm, right panel). These vesicles can be seen to move along microtubules.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A polarization microscope comprising:
a variable wavelength light source changing the wavelength of light;
a first polarizer optically coupled to the variable wavelength light source, wherein the first polarizer transmits polarized light;
a first retarder module optically coupled to the first polarizer, where the first retarder transforms the polarized light to a new polarization state as a function of wavelength, such that small changes in emission wavelength move the polarization state to new positions on the Poincare sphere;
a specimen stage optically coupled to the first retarder module, wherein the specimen stage holds a specimen in the optical pathway of the light received from the first retarder module;
a second retarder module optically coupled to the specimen stage, wherein the second retarder module is an opposite-signed retarder with respect to the first retarder module as to reverse the polarization transformation of light received from the specimen by an equal amount from the first retarder module;
a second polarizer optically coupled to the second retarder module, wherein the second polarizer transmits a state that is orthogonal to the first polarizer;
an optical capture device optically coupled to the second polarizer, wherein the optical capture device captures light passing through the second polarizer and captures images of the specimen after each change of wavelength of light.

2. The polarization microscope of claim 1, wherein the variable wavelength light source is capable of producing light having a wavelength from between about 350 nm to about 800 nm and changing emission wavelengths at a maximum speed of between 1 microsecond/wavelength and 5000 microseconds/wavelength.

3. The polarization microscope of claim 2, wherein the first polarizer and/or the second polarizer is a polarizing prism.

4. The polarization microscope of claim 3, wherein the first retarder module includes a first retarder, a second retarder, and a first wave plate; and the second retarders module includes a second wave plate, a third retarder, and a fourth retarder.

5. The polarization microscope of claim 4, wherein the first retarder is matched in thickness and optical retardation with the fourth retarder, and the second retarder is matched in thickness and optical retardation with the third retarder.

6. The polarization microscope of claim 5, wherein the first retarder, the second retarder, the third retarder, and the fourth retarder are selected from quartz or tellurium dioxide.

7. The polarization microscope of claim 4, wherein the first wave plate and the second wave plate are zero order retarders.

8. The polarization microscope of claim 4, wherein the degree of retardance of the retarders is based on the wavelength of the incident light.

9. The polarization microscope of claim 3, wherein the fast and slow axis of the third retarder are opposite to second retarder and the fast and slow axis of the fourth retarder is opposite to the first retarder.

10. The polarization microscope of claim 3, further comprising a first lens optically coupled between the first retarder module and the specimen stage; and a second lens optically coupled between the specimen stage and the second retarder module.

11. The polarization microscope of claim 10, wherein the optical capture device is a charged coupled device; and wherein the variable wavelength light source comprises a lamp housing including a xenon arc lamp illuminating an adjustable ellipsoidal mirror focused through an ultraviolet-blocking window and an exit slit; light exiting the exit slit passes to an adjustable flat mirror onto a beam block; the xenon arc lamp includes an arc lamp anode attached to a cooler and a ceramic insulating plate; the xenon arc lamp includes an arc lamp cathode connected to a cooler; the xenon arc lamp includes a plurality of position adjustment screws to position the xenon arc lamp; the arc lamp anode includes and the arc lamp cathode includes at least two high-voltage connections operably coupled to an external igniter and a power supply; and the lamp housing filled with a gas.

12. The polarization microscope of claim 11, wherein the light from the first retarder module passes through the specimen held on the specimen stage.

13. The polarization microscope of claim 11, wherein the light from the first retarder module is reflected off the specimen held on the specimen stage.

14. A method of visualizing a specimen using a polarization microscope comprising:
placing the specimen on a specimen stage of a polarization microscope as described in claim 1;
and obtaining images of the specimen at one or more wavelengths.

15. The method of claim 14, wherein obtaining images of the specimen comprises periodically changing the wavelength of light impinging on the specimen and capturing images of the specimen after each change of wavelength of light.

16. The method of claim 15, wherein each change of wavelength occurs in between 10 and 500 microseconds.

17. The method of claim 16, wherein imagining of the biological specimen is performed continuously over a time of at least about 2 seconds.

18. The method of claim 17, wherein the method further comprises modulating the polarization state of the light over the entire Poincare sphere by altering the wavelength of the light produced by the variable wavelength light source.

19. The method of claim 18, further comprising:
adjusting the transmission state of the first polarizer with respect to the second polarizer so that the first polarizer and the second polarizer are not orthogonal; and
obtaining images of the specimen while the first polarizer and second polarizer are not orthogonal.

20. The method of claim 19, further comprising calibrating the polarization microscope by determining the orientation state of the light when the second polarized light rotator and the second retarder module are removed from the optical path; and determining the orientation state of the light comprises rotating the second polarizer through discrete angles and analyzing the data collected by the optical capture device.
